(19) United States
(12) Patent Application Publication
(10) Pub. No.: US 2005/0129932 A1
(43) Pub. Date: Jun. 16, 2005

(54) Rivet and coating technique

(76) Inventor: Robert E. Briley, Acton, CA (US)

Correspondence Address: Fulwider Patton Lee & Utecht LLP;Atten: Alan C. Rose, Howard Hughes Center, Tenth Floor, 6060 Center Drive, Los Angeles, CA, 90045, US

(21) Appl. No.: 10/737,113

(22) Filed: Dec. 16, 2003

(51) Int. Cl. B32B 15/08; B05D 3/12; B05D 3/02; B32B 7/04

(52) U.S. Cl. 428/335; 428/457; 156/91; 427/327; 427/388.1

(57) ABSTRACT

A previously heat treated aluminum alloy rivet is sand blasted with aluminum oxide, washed with a corrosion resistant solution, dried, and then a coating is applied to the rivet. The coating includes solvent, resin, plasticizer and a corrosion inhibitor. The coating is cured at an elevated temperature below 300° F., preferably in the order of 250° F. for about an hour, or between one-half and one and one-half hours. The resultant rivet has a relatively thick gasket-like coating about 0.0007 to about 0.001 or 0.002 inch thick, and retains its high shear strength resulting from the initial pre-coating heat treatment. As an alternative pre-treatment, the rivets may be chromic acid anodized.

### FIELD OF THE INVENTION

This invention relates to coated aluminum or aluminum alloy rivets.

### BACKGROUND OF THE INVENTION

It has previously been proposed to coat rivets for protection against corrosion and deterioration. A coating for titanium rivets is disclosed in U.S. Pat. No. 3,979,351, granted Sep. 7, 1976 and in related U.S. Pat. No. 3,983,304, granted Sep. 28, 1976. In the field of coated aluminum or aluminum alloy rivets, a number of prior patents disclose concurrently curing the coating and heat treating the aluminum alloy rivets. These include the following patents: U.S. Pat. No. 5,944,918, granted Aug. 31, 1999; U.S. Pat. No. 5,858,133, granted Jan. 12, 1999; U.S. Pat. No. 6,221,177 granted Apr. 24, 2001; U.S. Pat. No. 6,274,200 granted Aug. 14, 2001; and U.S. Pat. No. 6,403,230, granted Jun. 11, 2002. Aluminum alloy rivets require special heat treating in order to increase their strength; and the foregoing patents discuss these required heat treatments in some depth. The specifications of these patents, which include discussions of aluminum alloy heat treating are hereby incorporated into this specification by reference.

It is noted, however, that once an aluminum alloy rivet has been heat treated, additional heating of the rivet to a temperature above about 300° F. to cure a coating applied to the rivet, will impair the shear strength of the rivet.

It is further noted that, with the coatings disclosed in these patents, and the high temperatures used for concurrently both curing of the coating and heat treating of the rivets, the coating is relatively thin, such as about 0.0002 to 0.0005 inch.

### SUMMARY OF THE INVENTION

In accordance with the present invention it has been determined that rivet coatings may be cured at a relatively low temperature, such as about 250° F. This has many advantages, including avoiding any impairment of the strength of the rivets. In addition it provides a somewhat thicker coating on the rivets so that the coating acts somewhat like a gasket, preventing the flow of water or the like past the rivet. More specifically, the coating is about 0.0007 to about 0.001 or 0.002 inch in thickness. In addition, the coating is softer and more resilient than prior coatings baked at high temperatures.

The coating may be somewhat similar to that disclosed in the coating for titanium rivets in the —351 and —587 patents, including a resin, solvents, a corrosion inhibitor, and an elasticizer. However, instead of baking at higher temperatures, and concurrently heat treating the rivet and curing the coating, the curing is accomplished at about 250° F., with previously heat treated aluminum or aluminum alloy rivets, so that the shear strength of the rivets is not impaired.

In addition, as a pre-treatment, the rivets may be sandblasted, preferably with aluminum oxide, and treated with a solution such as alodine containing material such as chromic acid and a compound containing fluorine.

Instead of the pre-treatment outlined in the preceding paragraph, the rivets may be chromic acid anodized. This type of treatment is known per se and is described, for example, in a text entitled “Coating and surface Treatment for Metals”, by J. Edwards, ASM International, Finishing Publications, Ltd. In which see particularly page 37.

In accordance with a specific method illustrating the principles of the invention, the aluminum alloy rivets may be initially heat treated. Subsequently, after any desired time interval, the rivets may be sandblasted and washed. Following drying, the rivets are coated with a coating including (1) solvents, (2) Resin, (3) a plasticizer and (4) a corrosion inhibitor. The coating is then cured at a temperature of between about 230° F. and 290° F. for between ½ hour and 1½ hours preferably for about an hour. The rivets are later employed in securing two work pieces together, with the thick coating, about 0.0007 to 0.001 or 0.002 inch thick, functioning somewhat like a gasket to seal the rivet hole.

Advantages of the present invention include (1) increased thickness of the coating; (2) no time constraints are required relative to the time of coating the rivets.

Other objects, features and advantages of the invention will become apparent from a consideration of the following detailed description and from the accompanying drawings.

### BRIEF DESCRIPTION OF THE DRAWINGS

FIG. 1 is a schematic showing of an aluminum alloy rivet with a coating on its surface.

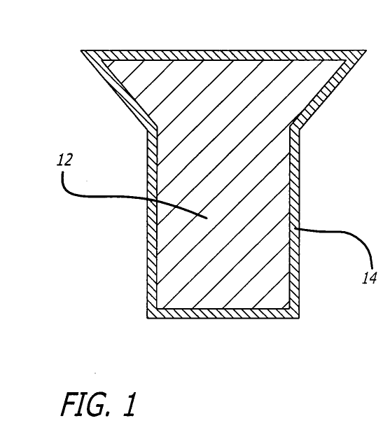

### DETAILED DESCRIPTION OF THE PREFERRED EMBODIMENTS

While the specification describes particular embodiments of the present invention, those of ordinary skill can devise variations of the present invention without departing from the inventive concept.

Referring more particularly to the single figure of the drawings, it shows an aluminum alloy rivet with a coating 14 on its outer surface. The rivet is initially heat treated to increase its shear strength, with the elevated temperatures and the time of heat treatment depending on the particular aluminum alloy which is employed. The heat treated rivet may be stored for extended periods of time, or may be coated soon after heat treatment.

The aluminum alloy rivet often has a somewhat oxidized outer surface. The rivets are sandblasted, preferably with aluminum oxide, and washed with an oxidation inhibiting solution, preferably Allodine®, a solution containing chromic acid and a fluorine compound. This material is available from Henkel Surface Technologies, 32,100 Stephenson Highway, Madison Heights, Mich., 48071.

Following drying, the rivets are coated by spraying, dipping or other methods with a coating preferably containing the following:

| Material | Grams | % |
|---|---|---|
| Solvents: | | |
| Methyl Ethyl Ketone (MEK) | 1,250 g. | 35 |
| Ethyl Alcohol | 1,250 g. | 35 |
| Corrosion Inhibitor: | | |
| Strontium Chromate | 260 g. | 7 |
| Elasticizer: | | |
| Polyvinyl Butyral | 60 g | 2 |
| Resin: | | |
| Phenol-Formaldehyde | 752 g | 21 |
| Color (Optional): | | |
| Blue Dye | 10 g | Less than 1% |
| TOTAL | 3,582 g | |

While the foregoing represents a preferred coating, it is to be understood that minor departures from the proportions, and the substitution of equivalent materials may be accomplished to achieve the objects of the invention.

Following coating, the rivets are preferably cured at a temperature of about 250° F. for one hour. The temperature may be within the range of from 220° F. and 290° F. preferably between 240° F. and 260° F., and the time of curing may be increased somewhat for lower temperatures and increased somewhat for higher temperatures but should preferably be between ½ hour and 1½ hours. As noted above, the shear strength of the rivets may be impaired with temperatures above 300° F., so it is desirable to stay below this temperature.

Concerning the composition of the coating, the percentages set forth above are preferred, but variations are still operative. Thus, instead of the listed solvents, they may be replaced in whole or part with toluene or acetone, with the speed of drying being in the order of acetone, MEK, Ethyl alcohol and toluene. Thus by way of example and not of limitation, the amount of Ethyl alcohol may be reduced somewhat and some acetone added. Similarly, other equivalent materials may be substituted in whole or part for the corrosion inhibitor, the elasticizer and/or the resin. It is further noted that in some cases where the heat treated rivets are clean and unoxidized, the initial sand blasting step may not be needed.

In closing, it is to be understood that the foregoing detailed description relates to the preferred method and coated rivet; and various changes and modifications may be made without departing from the spirit and scope of the invention.

1. A method comprising the steps of:
heat treating aluminum alloy rivets to increase their shear strength;
sand blasting the rivets with aluminum oxide;
washing the rivets with a solution containing chromic acid and a fluorine compound;
applying a coating of a solution of a solvent, a resin binder, strontium chromate and an elasticizer to the rivet;
curing the coating at a temperature between about 230° F. and 290° F. for a time period of between about one half hour and one and one half hours to produce a gasket-like coating on the rivet having a thickness of about 0.0007 to about 0.001 inch; and
riveting two workpieces together with the coating sealing the rivet, and with the rivet retaining its full heat-treated shear strength.

2. A method as defined in claim 1 wherein the rivets are cured at a temperature of between 240° F. and 260° F.

3. A method as defined in claim 1 wherein the solvent is Methyl Ethyl Ketone and Ethyl alcohol, the elasticizer is Polyvinyl Butyral, the resin is a phenolic resin, and the corrosion inhibitor is Strontium chromate.

4. A method comprising the steps of:
obtaining a supply of aluminum alloy rivets which have been heat treated to increase their shear strength;
sand blasting the rivets;
washing the rivets with a solution containing oxidation inhibiting material;
applying a coating of a solution of a solvent, a resin binder, strontium chromate and an elasticizer to the rivet; and
curing the coating at a temperature between about 230° F. and 290° F. for a time period of between about one half hour and one and one half hours to produce a gasket-like coating on the rivet having a thickness of about 0.0007 to about 0.002 inch;
whereby the rivets retain their full heat treated shear strength, and seal the rivet holes when the rivets are riveted in place.

5. A method as defined in claim 4 wherein the rivets are cured at a temperature of between 240° F. and 260° F.

6. A method as defined in claim 1 wherein the solvent is Methyl Ethyl Ketone and Ethyl alcohol, the elasticizer is Polyvinyl Butyral, the resin is a phenolic resin, and the corrosion inhibitor is strontium chromate.

7. A coated rivet made in accordance with the method of claim 4 said rivet being a heat treated aluminum alloy rivet with a gasket-like coating having a thickness of between about 0.0007 and 0.002 inch thick.

8. A method comprising the steps of:
heat treating aluminum alloy rivets to increase their shear strength;
applying a coating of a solution of a solvent, a resin binder, a chromate compound and an elasticizer to the rivet;
curing the coating at a temperature between about 230° F. and 290° F. for a time period of between about one half hour and one and one half hours to produce a gasket-like coating on the rivet having a thickness of about 0.0007 to about 0.001 inch; and
riveting two workpieces together with the coating sealing the rivet, and with the rivet retaining its full heat-treated shear strength.

9. A method as defined in claim 8 wherein the rivets are cured at a temperature of between 240° F. and 260° F.

10. A method as defined in claim 8 wherein the solvent is Methyl Ethyl Ketone and Ethyl alcohol, the elasticizer is Polyvinyl Butyral, the resin is a phenolic resin, and the corrosion inhibitor is Strontium chromate.

11. A method comprising the steps of:
obtaining a supply of aluminum alloy rivets which have been heat treated to increase their shear strength;
applying a coating of a solution of a solvent, a resin binder, a corrosion inhibitor, and an elasticizer to the rivet; and
curing the coating at a temperature between about 230° F. and 290° F. for a time period of between about one half hour and one and one half hours to produce a gasket-like coating on the rivet having a thickness of about 0.0007 to about 0.002 inch;
whereby the rivets retain their full heat treated shear strength, and seal the rivet holes when the rivets are riveted in place.

12. A method as defined in claim 11 wherein the rivets are cured at a temperature of between 240° F. and 260° F.

13. A method as defined in claim 11 wherein the solvent is Methyl Ethyl Ketone and Ethyl alcohol, the elasticizer is Polyvinyl Butyral, the resin is a phenolic resin, and the corrosion inhibitor is strontium chromate.

14. A coated rivet made in accordance with the method of claim 11 said rivet being a heat treated aluminum alloy rivet with a gasket-like coating having a thickness of between about 0.0007 and 0.002 inch.

15. A method comprising the steps of:
obtaining a supply of aluminum alloy rivets which have been heat treated to increase their shear strength;
pre-treating the rivets to provide a clean surface free from oxidation or contamination;
applying a coating of a solution of a solvent, a resin binder, a corrosion inhibitor, and an elasticizer to the rivet; and
curing the coating at a temperature between about 230° F. and 290° F. for a time period of between about one half hour and one and one half hours to produce a gasket-like coating on the rivet having a thickness of about 0.0007 to about 0.002 inch;
whereby the rivets retain their full heat treated shear strength, and seal the rivet holes when the rivets are riveted in place.

16. A method as defined in claim 15 wherein the rivets are cured at a temperature of between 240° F. and 260° F.

17. A coated rivet made in accordance with the method of claim 11 said rivet being a heat treated aluminum alloy rivet with a gasket-like coating having a thickness of between about 0.0007 and 0.002 inch.

18. A method as defined in claim 15 wherein the pre-treating involves sand blasting the rivets and washing the rivets in an acid solution.

19. A method as defined in claim 15 wherein said pre-treatment involves chromic acid anodizing of the rivets.
